(19) United States
(12) Patent Application Publication
(10) Pub. No.: US 2019/0012386 A1
(43) Pub. Date: Jan. 10, 2019

(54) METHOD AND DEVICE FOR FLEXIBLE RANKING SYSTEM FOR INFORMATION IN A MULTI-LINKED NETWORK

(71) Applicant: Technische Universitaet Darmstadt, Darmstadt (DE)

(72) Inventors: Volker Betz, Darmstadt (DE); Stephane Le Roux, Uccle (BE); Martin Ziegler, Daejeon (KR)

(21) Appl. No.: 15/641,536

(22) Filed: Jul. 5, 2017

(51) Int. Cl. G06F 17/30

(52) U.S. Cl. CPC G06F 17/30867; G06F 17/3053

(57) ABSTRACT

A method obtains a relative importance ranking of a subset of nodes. The ranking is based on a structure of the links between nodes, and on weights that determine the importance of the links. The method includes forming pairs of nodes a, b; performing a random walker method for each formed pair using the link weights for determining the next random step and checking whether the random walker arrives at b without returning to a. The method then performs the random walker method with the roles of a and b interchanged by starting from b. The method compares the successful journeys from a to b to the total number of journeys to obtain a reachability score for b when starting from a. The reachability scores from a to b compared to the score from b to a provides a measure for the relative importance of the nodes.

### BACKGROUND

### 1. Field of the Invention

The invention relates to a device or method running on the device, executed by a processor of a computer system, to obtain a relative importance ranking of a subset of nodes of a larger, multiply linked set of nodes, wherein a link defines a reference from one node to another node, so that each node provides information about nodes that are linked; the ranking is based on a structure of the links between the nodes, and on link weights that determine the importance of said links.

### 2. Description of the Related Art

The situation is that there are large computer networks (e.g. the world wide web) consisting of nodes (e.g. computer systems providing web pages of the www) and directed connections between those nodes (e.g. the links from one web page to another). The connections can be of different strength.

Importance ranking of entries of a large, multiply linked data base is an extremely important and common problem. For example, the small subset could be the result of a database query, or more specifically the set of all the web pages containing the word ‘motor’. The importance ranking will usually be based on the network structure. Most common ranking mechanisms make direct use of the link structure of the network. Arguably the most famous instance is the original algorithm of Google which ranks the web sites of the world wide web. The mechanism of that algorithm can be described as follows:

A ‘random walk’ is set up on the linked network, in the sense that when a ‘walker’ is currently at a node x of the network, it jumps to a random, different node in the next step. The precise node to which it jumps is usually selected using the link structure of the network. In the most basic implementation of Googles algorithm, the walker first throws an unfair coin, which comes up heads with (usually) probability 0.15 (Conceptually in an unbiased or fair coin both the sides have the same probability of showing up i.e. ½=0.50 or 50% probability exactly. Wherein within a biased or unfair coin probabilities are unequal. That is any one side has more than 50% probability of showing up and so the other side has lesser than 50% chances of turning up). If it does come up heads, the walker chooses a node from the whole network at random (each with equal probability), and goes there. If the coin comes up tails, the walker chooses at random, with equal probability, one of the nodes which is connected to its current location by an http link. For each node, the amount of times that the walker jumps to this node is divided by the total number of steps taken. General mathematical theory assures that these quantities approach a limit when the number of steps becomes very large. This limit is a number between 0 and 1, and serves as the score of the given node. The importance ranking now is such that among the hits of a given search query, nodes with higher scores are displayed first.

An equivalent formulation of this mechanism is that the links between the nodes carry a certain weight. In the above example, it is assumed that method is at a node x which has links to a total of 7 other nodes in the network, and that there is a total of N nodes in the network. Then each of the 7 links leading from x to another node obtains a weight of 0.85/7, and a system or a user introduce additional links from x to every node of the network with a link of 0.15/N each. Note that all the link weights sum up to one. Thus, an algorithm that picks a weighted link from the totality of links leaving x and follows it will lead to the same random walk as in the Google algorithm.

The formulation using link weights offers more flexibility than the original Google algorithm. In particular, since the link weights directly influence the resulting ranking, one can think of deliberately strengthening certain link weights at the expense of others, simulating a random walker that prefers certain jumps to others. For example, instead of the links with strength 0.15/N to the whole network, the invention may pick a subset of the network, e.g. containing M nodes, and only introduce links from each x to that subset with a probability of 0.15/M. This approach becomes more powerful when the subset can depend on the search result and/or user interaction, allowing the user to indirectly control the criteria by which the ranking is obtained. An obstacle to this idea is that in very large networks, it may take a very long time to compute a ranking using (the equivalent of) Googles algorithm, making it impossible to obtain user specific rankings in real time. A central point of the current invention is a method and system that makes this real time computation possible.

There are several extensions and refinements of the Google algorithm. One has to do with the removal of ‘dangling nodes’ which are nodes that have no outgoing links (“Googles Search Engine and Beyond: The Science of Search Engine Rankings” by Langville and Meyer, published 2012 by Princeton University Press. For the policy of ranking down non https sites, see e.g. https://webmasters.googleblog.com/2014/08/https-as-ranking-signal.html). Others have to do with changing the mechanism with which the random walker picks its next step. For example, it is well known that web sites not meeting certain criteria (like e.g. offering secure communications) are ‘ranked down’, which may be done by decreasing the probability of the random walker to visit these web sites.

Existing ranking algorithms usually fall into two categories:
(1) They use the full network structure in order to compute an importance ordering for all nodes. This global ordering is then used to rank the nodes in the small subset. Googles original algorithm is the most famous example of such a strategy.
(2) They assume that a global ordering (such as detailed in the point above) has been made, and refine this ordering by using properties of subset of nodes. Such properties might include the connections between the nodes, user feedback on the utility of the ordering, or contextual information.

Both approaches only work based on the results of the given search query, without taking any other part of the network into account. However, this may lead to very different, and potentially less good, importance ranking. For example, it is assumed that the user searches for the term ‘gift’ (which means ‘poison’ in German) and obtains a result set containing English and German web sites. If the user is only given the option to rank up all search results that are in German, but based on the ‘standard’ ranking obtained from a random walker on the whole web, the results may be very different from a ranking that would be obtained by strengthening all the link weights between German language web sites, and at the same time weakening links to English language web sites; the latter would correspond to a walker that is only allowed to (or will strongly prefer to) visit German language sites in the first place.

The disadvantage of approach (1) above is that it is not very flexible and takes a long time to compute. In particular, it is not possible to include user defined ranking criteria in real time. Instead, the system needs to anticipate some common requests (such as preferring web pages in German) and to pre-compute a ranking for them. This means that an interactive re-ranking of search results is impossible or at least rather limited. Secondly, even a small change in the network structure usually needs a full re-computation of the importance ordering. So, problem b) below is not solved by the method.

The approaches of (2) (disclosed in U520150127637 A, U52008114751 A, U52009006356 A, U.S. Pat. No. 6,012,053B, U.S. Pat. No. 8,150,843B are trying to solve problem a) and to provide real time interactive methods of re-ranking. Their limitation is that they only consider the subset that was e.g. returned by the search query. However, this subset will usually be embedded into a larger neighborhood that may influence its ranking strongly. In the presented example, web pages containing the word ‘car’, ‘airplane’ or ‘lawn mower’ might be strongly linked to the web pages containing the ‘motor’ and would influence their ranking. Given the many possible search terms, it would however be impractical to amend the methods of (2) by considering ‘enlarged’ sub-networks, since the choice of these networks would be difficult to make. So, problem a) cannot be solved in a satisfactory way by the existing approaches, and they do not offer any way to solve problem b).

In real world situations, it is often desirable to let the user select the link weights between the nodes, and then determine the importance ranking that results from the new link structure. Here are three examples:

1. One may give the user the chance to decide whether they want to rank down non-secure web sites, and by how much. In this case, the weight of any link to a non-secure web site would be reduced by a user specified amount.

2. One may give the user the opportunity to strengthen link weights between web sites written in a certain language only, and at the same time perform the ‘random’ jump (corresponding to the 0.15 side of the unfair coin) only to web sites in that language.

3. The data base may constantly change by addition of new nodes and/or links, and it is intended to keep it up to date in real time.

In all three examples, what has to be done is to order (or re-order) a small subset of the database according to an importance ranking that cannot be pre-computed, and thus has to be determined in real time. The reason for not being pre-computable is that the importance ranking will depend on the link strengths that are given by the user, or by the change in the network structure. Also, since it is not reasonable to assume that the random walker will only walk on the small subset that is returned by the search query, the new importance ranking will depend on strengths of links between sites which are not in the small subset that needs to be ranked.

In summary, it would be desirable to have a method that achieves the following: when given a subset of nodes that should be compared, and a set of weighted links between all nodes of the network, the method returns (a good approximation of) the importance ranking that the random walker algorithm would give with the set of weighted links. This should happen fast enough to be suitable for real time applications.

### SUMMARY

The invention presents a system and method to provide an importance ranking for a small subset of nodes of a large linked network, where each link can have a strength attributed to it. The calculation has to be performed with a high speed. The system receives as input a subset of relevant nodes/elements, and a full set of link strengths. It provides an importance ranking that is similar to the one that would be obtained by running the ‘random walker’ algorithm on the whole linked network with the given linked weights. It will only compute the importance ranking for the relevant small subset of nodes, and therefore can be much faster than existing approaches. At the same time, it uses more information of the network structure than is contained in the small subset of nodes and the links connected directly to them. This way, it can possibly give more useful rankings than methods based on the information in the small subsets alone.

This invention allows
a) The interactive re-ranking of search results based on user-defined criteria. This would allow the user to manipulate the original network structure according to their needs, thus influencing the search rankings. In the example of the world wide web with its connections given by hyperlinks, the user could of strengthen all link weights between web sites containing the word ‘motor’, strengthen or weaken link weights to commercial sites, or weaken link weights to sites that have been ‘greylisted’ for suspected link farming. The user could also control, via a parameter, how strongly he wants to implement the desired changes. The resulting changes to the search ranking should be calculated and displayed in real time.
b) Fast maintenance of the ranking after small changes in the network structure. Here, an example would be a new web page that becomes linked to the world wide web, or new links between existing web pages. These events will change the network structure and thus the importance ranking. Object is a fast method of estimating these changes without re-examining the full network.

One first idea of the invention is that instead of computing the importance weights of all the nodes in the network, the invention computes importance ratios between different nodes. With the help of the importance ratios for a small subset of nodes, both tasks a) and b) can be achieved.

The basic working mechanism of the invention is to use reachability as a measure for comparing the importance of two nodes. Let p(a->b) be the probability that a random walker starting from a node a reaches node b before returning to node a. Broadly speaking, the idea of reachability is that node a is more important than node b if it is easier to reach a when starting from b than the other way round. In other words, a is more important than b if p(b->a) is bigger than p(a->b). The difference of importance can be quantified, as will be explained below.

Assume that one wants to compare the importance of two nodes a and b. Their ‘true’ importance weight is given in the sense of the Google algorithm, i.e. via the network structure by the stationary distribution of the Markov chain induced by the network. Assume that w(a) is the true importance weight of a and w(b) is the true importance weight of b. In other words, one could calculate w(a) and w(b) by running the Google algorithm for the full network. It is a result of the paper [1]: (reference: V. Betz and S. Le Roux, Multi-scale metastable dynamics and the asymptotic stationary distribution of perturbed Markov chains, Stochastic Processes and their Applications 26 (ii), November 2016) that the ratio w(a)/w(b) is exactly equal to the ratio r(a,b)=p(b->a)/p(a->b). Therefore, r(a,b) will be called the importance ratio of the nodes a and b.

One second idea of the invention is that while it is difficult to approximately compute w(a) without at the same time computing the weights for all other nodes of the system, it is easy to approximately compute p(b->a) and p(a->b) based only on local information. This provides a faster way to calculate an (approximate) importance ordering for selected database entries without at the same time calculating the weights of the whole remaining network.

The invention provides an explicit recipe for computing the approximate importance ratios. The claimed approximate method of computing importance ratios works by starting a ‘random surfer’ at a and let it perform a random walk along the network guided by the links and link weights between the nodes, in the same way that the Google algorithm does. Explicitly, when the surfer is at a node c, it will go to another node d with probability proportional to the link weight of the link between c and d (which may be zero). For this algorithm, it is not necessary that the link weights sum up to one: assume that there are links to the nodes d(1), . . . d(n) of the network, with corresponding link weights s(1), . . . s(n). Then the surfer will choose the node d(i) with probability p(i)=d(i)/(d(1)+. . . +d(n) . . . The difference to the Google algorithm is that in Googles algorithm the surfer has to explore the whole network for a very long time, and the importance weight of the node a is then the proportion of time the surfer spent on a. In contrast, the claimed algorithm stops as soon as the surfer starting from a either hits the node b or returns to a. If it hits b, it is defined that the surfer made a successful journey, if it returns to a it is defined that the journey was a failure. The method repeats this procedure many times (or runs it in parallel, which improves also the speed and the computing efficiency) and records the success ratio J(a,b), i.e. the number of successful journeys divided by the number of all journeys. The method then starts a surfer from b and record the ratio J(b,a) of successful journeys from b to a. The quotient R(a,b)=J(b,a)/J(a,b) of journey success ratios then approaches the importance ratio r(a,b)=p(b->a)/p(a->b) by the Ergodic Theorem. Since by the results of [1], r (a,b)=w(a)/w(b), computing J(b,a)/J(a,b) provides an approximation of the importance ratio without exploring the whole network. The approximation can be quite good even after a relatively short computing time: in most cases, the journey will either be a success or a failure long before the surfer explores the whole network. Thus, the claimed algorithm is much faster than the standard Google algorithm.

If a journey does take too long before completing, there are several reasons why this might happen, and several measures the method can take. In some cases, the surfer can get caught in a relatively small area, let it be called E, of the network that is hard to leave. In these cases, the one can compute the occupation ratios v(c) for each node c of E by dividing the number of visits to c by the total number of steps in E. Then, an effective rescaling of running time as described in [1] is possible: one has to use formula (4.6) in the cited reference, with the difference that one replaces the quantities nu_E(c) given there by the approximate quantities v(c). That formula gives an explicit set of alternative weights that can be used to jump from any point in E directly to one of the points on the boundary of E. It is sensible to store these alternative weights for future random walkers and to use them immediately if one of them enters of re-enters E. It is also possible (and sensible) to use this method recursively if necessary.

Another possible source of failure of the method is that the success rate is too small, meaning that most journeys starting in a also end in a. If this is the case, one has to use formula (4.5) of [1], where x is the starting point a, and again the nu_E(c) are replaced by the approximate occupation ratios v(c). Again, this change should be recorded for future walkers, and may need to be applied recursively.

Finally, it is possible that the walker runs for a long time without finding either a or b, even after rescaling. In this case, the method cancels the journey completely and does not count it towards the total number of journeys. The number of cancelled journeys should be recorded as well, as it can give a measure of accuracy for the resulting ranking: a high number of cancelled journeys suggests that the computed ranking may be of low quality.

In the following, some more variants and features of the model are given:
(i) In most implementations of the ranking by link structure, the System keeps an image of the data base (e.g. the world wide web and its hyperlink structure containing a reduced amount of information) in memory, along with its link weights. The algorithm computing the importance weights then needs access to the full structure of that network. However, since in the claimed method the walkers explore only a small part of the network, the method does not need to keep the full network structure in memory. If the method run by a computer only wants to compare the importance of a and b, the method can just let a random surfer start from each node and explore the network structure together with the surfers: whenever a surfer goes to a node where it has not been before, the connection structure of that node is added to the network (and used again if the surfer visits that place again). This way, the method can make importance comparisons without knowing most of the network. While this may lead to longer computing times since the method needs to resolve the network structure on the fly, it will use far less memory and can be done locally. In some applications, it may even be possible to avoid storing an image of the full network structure and determine the relevant nodes and link strengths on the fly by probing the real network; in the case of the world wide web this can be impractical however, due to long load times of web sites and heavy web traffic caused by the method.
(ii) If the set A of nodes that is to be compared has n elements, it is not always necessary to compute all of the (n−1)² quantities R(a,b). Since w(a)<w(b) and w(b)<w(c) implies w(a)<w(c), r(a,c) need not be computed if r(a,b) and r(b,c) are known.
(iii) A consistency check is possible. It has been mentioned that the R(a,b) are only approximately equal to the ratios r(a,b)=w(a)/w(b). If they were exactly equal, then for three nodes a,b,c the identity R(a,b) R(b,c)=r(a,b) r(b,c)=(w(a)/w(b))(w(b)/w(c))=w(a)/w(c)=r(a,c)=R(a,c) would be valid. Therefore, if the quantity |1−R(a,b) R(b,c)/R(a,c)| is too large, this suggests that the method has not run long enough and needs to spend more time for these particular nodes.
(iv) For a given set A of nodes that need to be compared, all the computations of the different r(a,b) for a,b in A can be run independently of each other. Also, each random walker for the same pair a,b can be run independently of each other walker, they only have to record their successes and failures at a central point. This makes the method very easy to parallelize and thus potentially very fast.

In the following application scenarios and examples of the invention are given.

1) The interactive re-ranking based on user-defined criteria as mentioned above is handled as follows: It is assumed that a search query returned a subset A of nodes. It is also assumed that a criterion changing the strengths of the connection between arbitrary nodes of the network is given. This criterion may be specified by the user, or it may depend on the results of the search query. In addition to the examples given in the previous section, a possible change would be the following:

In Googles original algorithm, the ‘random surfer’ jumps to a completely arbitrary place in the world wide web with probability 0.15 in every step. A user or an external system could replace this by the prescription that the random surfer jumps to an arbitrary element of a given subset B of nodes. B can be the set A of results from the search query, can contain A but be larger than A or can be entirely unrelated to A, e.g. all sites in a given language. This way, the web graph would depend on the search result. If B contains A, the chance of the surfer getting permanently lost, i.e. the number of cases where a journey is neither a success nor a failure after many steps, is greatly reduced.

The definition of the subset can be based on several technical parameters as language preferences setup in the computer, the geo-location, or the usage history stored on the computer etc.

In another context, a content blocker (e.g. parental control) can decide to not only block given sites, but also weaken connections to sites that are either forbidden or heavily linked to forbidden sites, so these become harder to find, and their ‘opinion’ counts less when ranking the allowed sites.

On a mobile device, certain search services (like restaurant search) may decide to strengthen links based on geo-location of the device, detected by sensors, or address data provided in the web site.

With the new set of weighted connections, each of the search results a has a new importance weight w(a). Items with relatively large w(a) should appear at the top of the results list. The weights w(a) cannot be pre-computed as they depend on the search results or the user interaction. They could in principle be computed by running a Google algorithm on the full network, but this is too slow for real time. Instead, the fast comparison algorithm proposed by the invention computes some or all of the approximate reachability ratios R(a,b). Then, it is now possible to compare the importance of a node a with the importance of another node b: if r(a,b)>1, then a is more important than b. The final order in which the search results appear can now be determined by standard sorting algorithms, using that comparison.

2) Fast maintenance of the ranking after small changes in the network structure (see above b)). It is assumed that the network has changed at a node a, in that there is a new connection from a to some other nodes. This will change the importance weight of a, but also of some of the neighboring nodes. To compute the change, the method of the invention starts random surfers from the node a and determine a set A of nodes where the change of a may have effects. One way to do this is to simply start many random surfers from a and let A+ be the set that a good number of them reaches in the first hundred steps or so. A+ is the set that can be easily reached from the node a. The method of the invention should or can also run this process on the inverse network where every connection of the original network nodes in the reverse direction. This will give to the invention a set A− of nodes from which it is easy to get to a. A will then be the union of A+ and A−. It is known that the method of the invention calculates the ratios R(c,d) for all c,d in the set A, and determines the new weights by these ratios. One possible way the method is implementing this is to find nodes in A that are relatively weakly connected to a. A node b is weakly connected to a if there is a node c outside of A such that the both the fractions J(b,c) and J(c,b) of successful journeys from b to c and back are much larger than the corresponding ratios from a to b. Such a node will only be weakly influenced by changing the network around a, and it can thus be assumed that the weight of b stays the same. The remaining weights of nodes in A can then again be computed by their ratios with w(b), and their mutual ratios offer a consistency check such as given in (ii) above. The new weights will then replace the old ones.

According to the claims an important aspect of the invention is a method, executed by a processor of a computer system, to obtain a relative importance ranking of a subset of nodes of a larger, multiply linked set of nodes, wherein the nodes and links form a network, and wherein the links may have link weights attributed to them, wherein a link defines a reference to information stored on the nodes, so that each node provides information that are linked, the ranking is based on a structure of the links between the nodes, and is based on link weights that determine the importance of said links, comprising following steps:
forming a set of pairs, each consisting of two nodes a, b, of the subset of nodes to be ranked;
computing for each pair a,b a set of reachability scores R(a,b) and R(b,a), wherein the number R(a,b) reflects the probability that some random walk mechanism starting from a, and with a step distribution based on the weighted link structure of the network, reaches the node b before returning to its starting point a, and wherein the number R(b,a) is computed in the same way, with the roles of a and b exchanged;
storing the relative size of the reachability scores as a measure for the relative importance of the nodes;
ranking the full subset of nodes by using a sorting algorithms, using the stored relative importance of the nodes as a value of comparing two nodes and providing the ranked full subset of nodes as a relative importance ranking.

In a preferred embodiment the reachability score is computed in the following way:
performing for each formed pair a, b of nodes, a random walker method using the link weights for determining the next random step starting from a, and checking whether the random walker arrives at b without returning to a, if this happens, recording a journey as successful, performing the same with the roles of a and b interchanged by starting from b using the random walker method, performing the step several times according to a predefined repetition threshold, and storing the results of the journeys;
comparing for each pair a, b, the number of successful journeys from a to b to the total number of journeys, giving the reachability score R(a,b).

According to the claims an important aspect of the invention is a method, executed by a processor of a computer system, to obtain a relative importance ranking of a subset of nodes of a larger, multiply linked set of nodes, which are connected by a network, wherein a link defines a reference to information stored on the nodes, so that each node provides information that are linked, the ranking is based on a structure of the links between the nodes, and is based on link weights that determine the importance of said links. A possible embodiment is computer network, wherein each computer provides a service on which linked data is stored. The computer or the services running on the computer represent the nodes.

The service can be a http service also known as a web-service, or ftp service or any other service providing linked information. The links refer to external data on other nodes or to local data. A possible link can be a Hyperlink. The nodes can be addressed by URLs and path. A subset of the nodes can be a search result derived from a search using a search engine, providing the addresses as URLs. Also databases can be sources of the subset, storing the addresses of the nodes in relation to certain content or other relevant information.

The method comprises the following steps:
defining a method to compute weighted links from each node of the network to a subset of other nodes. Such a method can depend on the set of search results, on input by the user, on specifications of the client system or other parameters. An example for a possible method of computing weighted links are: for a given node x with n outgoing (unweighted) links in the original linked network of nodes, a weighted link with weight 0.85/n is created for each of the linked nodes, and a weighted link of weights 0.15/M is created between x and each node y of a fixed set of a total of M nodes. This set can be the set of a search result, or the set of nodes with a certain attribute, such as language in the world wide web. Another example for computing link weights in the same situation is to additionally increase or decrease the weight of a weighted link coming from the original connections depending on criteria of the node that is linked, such as belonging to a favoured or disfavoured part of the network, allowing secure communications (in the world wide web), or meeting certain other criteria depending on the content of the specific node. The end result is a prescription that allows a random walker to take a step from each x to a target node y with probability determined by the link weights. Note that positive link weights will usually occur even between nodes that are not linked in the original data base. This is indeed even the case in the original Google algorithm, where a link of strength 0.15/N is present from each node x to each node y, and where Nis the total number of nodes.
   forming a set of pairs, each consisting of two nodes a, b, of the subset of nodes to be ranked. The pairs can be formed randomly or systematically by a computer based on the addresses of the nodes in the subset.
   performing for each formed pair a, b of nodes, a random walker method using the link weights mentioned above for determining the next random step starting from a, and checking whether the random walker arrives at b without returning to a, if this happens, recording a journey as successful, performing the same with the roles of a and b interchanged by starting from b using the random walker method, performing the step several times according to a predefined repetition threshold, and storing the results of the journeys. The journeys can be performed on the real network, or on a copy stored in a database containing only the link structure and possibly other necessary information. The link weights will be calculated when a walker first visits a node x, according to the prescription given above that may depend some pre-assigned link weights that depend on the network structure, and/or on the subset that needs to be ranked, and/or other criteria. The link weights of sites that have been visited can be stored on the system for later use. Also, a local copy of the part of the network that has already been explored can be stored for later use and further local computations. In a very fast network a copy might not be needed, but in general a cached copy of the structure and some keywords, and not the whole content of the nodes can be used as a network structure.
   comparing for each pair a, b, the number of successful journeys from a to b to the total number of journeys, obtaining a reachability score for b when starting from a, storing the relative size of the reachability scores from a to b when compared to the score from b to a as a measure for the relative importance of the nodes;
   ranking the full subset of nodes by using a sorting algorithms, using the stored relative importance of the nodes as a value of comparing two nodes and providing the ranked full subset of nodes as a relative importance ranking.

In a possible embodiment the step of performing a random walker method for each pair a, b of nodes is computed in parallel. The computation can be performed on several servers within the network, or on a local client or a mixture of both.

The steps of the method can be calculated on a client computer, a server provides the necessary information about a network structure, and the client computer calculates the reachability score. This can be based on a copy of the network structure as mentioned above. It is also possible to perform this in the network itself if a fast access is given.

In a possible embodiment the prescription to compute link weights for a given node x is supplied by a user or by an external database,
wherein in case the user changes weights or additional links interactively, influencing the link weights, adjusting the ranking of the subset of nodes in real time to reflect these changes. For example, the user may change link weights by determining how strongly the weight of links to a certain ‘favoured subset’ of the network (e.g. the set that needs to be ranked) should be increased in comparison to other links. Examples can be found above.

In a possible embodiment the method comprises the step: Introducing a measure of quality into the ranking, defined by a record that stores how many journeys of the random walker have to be cancelled because neither a nor b is reached after a large predefined number of steps.

When displaying the measure of quality to the user the user is in the position to determine how much the ranking provided can be trusted. A high number of cancelled journeys is an indication, that the quality is minor. Wherein when a large number of journeys have been successful, then the quality might be high. The measure of quality can also be used to determine the order of nodes when there is a conflict in the sorting algorithm, which can happen as the reachability scores are not necessarily transitive due to the approximate nature of the computation.

In another embodiment the method can be used to maintain the relative importance ranking of a multiply linked set of nodes, when some entries or links are added or removed, comprising the step:
determining by a crawler a sufficiently large neighbourhood A of the node(s) of the network that has been changed, wherein the sufficiently large neighbourhood A is defined by threshold parameters; a crawler is a system which follows the links in the network using all links provided by a node. After a certain number of links followed the threshold parameter will stop the crawler.
computing a relative importance according to the steps of mentioned above for all the members of A; the link weights will in this case be determined by the (new) network structure, e.g. in the same way as they are determined in the Google algorithm.
identifying those entries of A that are only weakly affected by the change, but are still contained in the neighbourhood that has been computed; wherein a node b is weakly affected by the change if there is a node c outside A such that both the reachability scores J(b,c) and J(c,b) are much higher than the reachability scores J(a,b) and J(b,a) for any a in A that is connected to a link that has been added of removed; weakly connected nodes can be found by systematically testing this condition for those nodes of A where the graph distance to the nodes that have been affected by the change is maximal. The weakly connected node b keeps its old importance score w(b), while the other nodes in A obtain the new score w(b)*J(b,a)/J(a,b).

In one embodiment of the invention, the user provides the system with a data base query and additional parameters that can be used to modify the existing strengths of all the links in the network. The system will, in near real time, return the search results based on the query, ranked by the importance ranking based on the link strength parameters given by the user.

In a special case of the above embodiment, one can strengthen all the links between each pair of search results, and also restrict the completely random jumps that are sometimes done (those that do not follow any of the connections) to jumps between two search results. This is in a similar spirit as the existing local-Rank algorithm by Google, but is more powerful since it is not restricted to the search results alone. Also, the user can be allowed to choose the strength of the additional connections.

In another embodiment, the user sends a search query, and the system returns a result ranked by a standard importance ranking. The user is then given the opportunity to change certain parameters, and the system changes the order of the search queries in real time, depending on the parameters.

In yet another embodiment, one or more nodes, and/or additional links, are added to the network. The aim is to compute the (standard) importance ranking of the new nodes, and possible impacts on the existing nodes, in real time, in order to keep the system up to date. For this, in a first step for each new node or node with a new link, a ‘neighbourhood’ of other nodes is determined, and then a relative importance ranking is obtained by the reachability method, giving a new importance score for new nodes, and an updated importance score for existing nodes.

One advantage of the reachability approach is that if given a pair of nodes, one can compute the relative importance of those two nodes based on only the network structure near those nodes. This makes it possible to obtain an importance ranking for relatively small subsets of the data base (such as results of search queries) in real time, whereas traditional methods need to rely on pre-computed importance rankings.

### BRIEF DESCRIPTION OF THE DRAWINGS

FIG. 1 shows the embodiment of the invention where a ranking of the results of a search query is computed.

FIG. 2 shows the embodiment of the invention where the ranking according to the invention is used to locally update the importance rankings of a part of the network, after new nodes or links have been added to the network.

FIG. 3 shows a diagram illustrating the method of determining the reachability of a target node z from a start node a.

FIG. 4 shows a diagram illustrating the method of computing a relative importance ranking for a single pair of nodes.

FIG. 5 shows a diagram illustrating the working mechanism of the claimed ranking method for a set of relevant nodes.

### DETAILED DESCRIPTION

In the following two implementations are shown where the feature of reachability with respect to near nodes can be very useful.

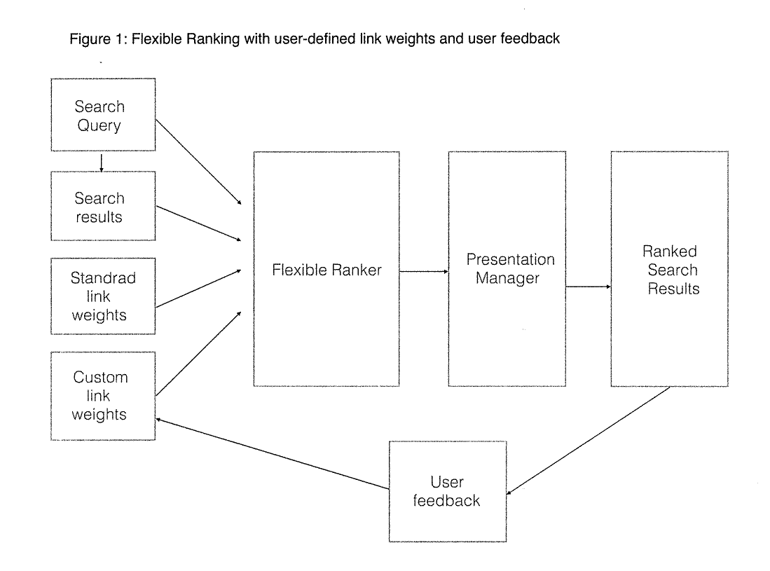

FIG. 1 shows a system for allowing the user to run an importance ranking using their own link weights in addition to link weights pre-determined by the system, and in addition to link weights that may be automatically but individually generated based on the results of the search query. The user starts a search query, which will return a set of search results. The user may also specify link weights of a modification of existing link weights, for the whole network, not only for the search results. In this context the user can also be an external systems, that requests certain information.

Examples would be that the user wants to strengthen links between web sites hosted by universities, or that the user decides to weaken links to web sites that receive many links (‘avoid crowded places’). In addition, it is possible that the new link weights make use of a standard set of link weights, a modification of link weights coming from the search query of the search results, or a combination thereof. These new link weights, along with the nodes that the user wants to be ranked (e.g. the results of their search query) are then given as an input to the ranker according to the invention. The ranker computes a ranking based on the data given by the user, and gives the ranked results to a presentation manager. As explained below, the ranker can not only rank search results, but also give an assessment about the quality of the relative rankings, so that the presentation manager can tell the user how much more important one data base entry is compared to the other, and how large the margin of errors is in the given ranking. This may or may not be presented by the presentation manager, depending on the circumstances and the user preferences. Seeing the results, the user can then give a feedback about the quality of the search results and change the weights accordingly. The system will update the ranking with the new weights. This procedure can continue until the user is satisfied with the ranking.

Two implementations are possible:

The ranker system can be run on the users machine using a suitable computer program or browser applet. In this case, the database system will communicate the local network structure to the user's machine, which will then do the ranking. This implementation has the advantage that it is scalable, in the sense that it can be used by many users at the same time, Or the rank system can run on a powerful and highly parallel architecture on the server side, which has the advantage that it can be very fast for a single user, since the method is very well suited for parallelization.

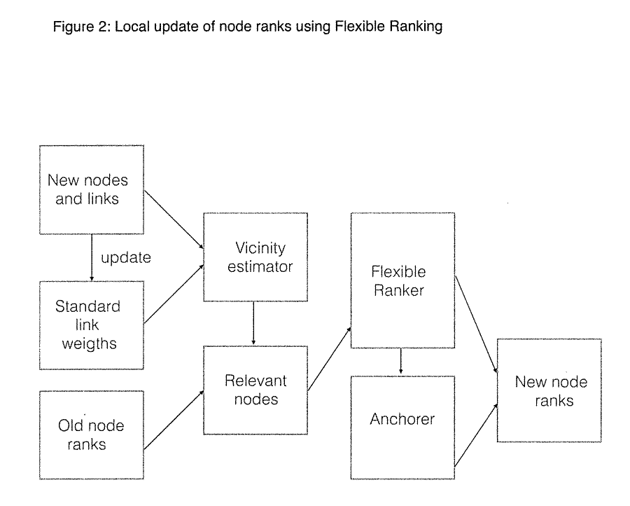

FIG. 2 shows an implementation where the rank system is used to maintain an importance ranking in a changing network. If new nodes and/or links are added to the multi-linked network, then the new nodes need an initial importance ranking; also, new nodes and new links will have an impact on the importance ranking of existing nodes. So, if new nodes and links are added to the network, first the standard network structure including the standard link weights are updated to reflect the change. Then, a vicinity estimator determines a region of the network that is a neighbourhood of the nodes that have been added, and of the nodes that have been connected by new links. The vicinity estimator can be similar to run a random surfer for a few hundred steps, as described above. This neighbourhood will then constitute the relevant nodes, i.e. the nodes that need to adjust their importance ranking. It is also possible to allow the old node rankings to have an influence on the selection of the relevant nodes. The relevant nodes, along with the updated network structure, are then fed into the importance rank estimator. After running, the estimator will produce a relative ranking of the relevant nodes, i.e. it will give information about the quotient of importance scores for each pair of relevant nodes. In order to obtain an absolute new importance ranking, these nodes are given to an ‘anchorer’. This anchorer will take into account the old scores of those relevant nodes that are comparably far away from the nodes that have been updated, and also the scores of nodes that are just outside the set of relevant nodes, and will thus compute a new absolute importance ranking for the added data base entries.

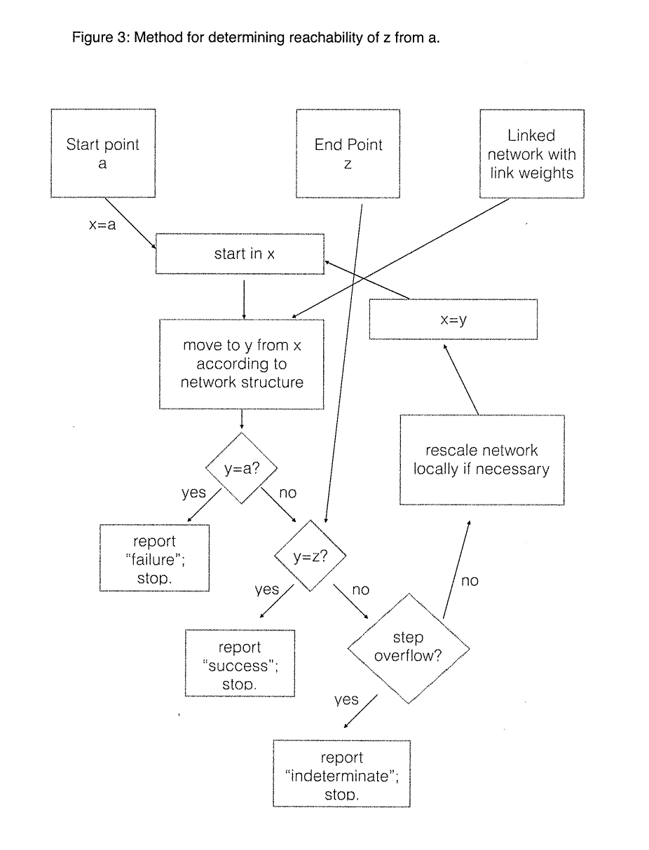

FIG. 3 shows the basic method for determining the reachability of a node z when starting from a node a. At each point in time, the method simulates a ‘random walker’ that is somewhere in the network. At each instant of time, call x the node where the random walker is. In the first step, x=a. At each time step of the procedure, the random walker then takes a random step to a node y. Which node y is selected depends on the link structure and weights that is given to the system. The system then checks whether the random walker has reached a. If so, the journey to z has failed, which is reported as an outcome. If not, it is checked whether the random walker has reached z. If so, the journey has been successful, and ‘success’ is reported as an outcome. If not, the system checks how many steps have already been taken. If the number is higher than a pre-defined constant, the journey is aborted, and the system reports that neither a nor z have been reached in a reasonable time. If this happens a lot of time, this is an indication that a and z are very far apart in the network, and also that a relative importance ranking between these particular two nodes may be of little value. If the step counter is not too high, it is checked whether the random walker has been caught in a ‘trap’, which is a region of the network that is hard to leave. An indication of a trap is that a relatively small number of sites has been visited a lot of times. If this is the case, the trap is ‘rescaled’ by a method described in the paper [1] of Betz and Le Roux, so that the trap is ‘lifted’. The step counter is reset to zero, and the network structure is adapted accordingly. Whether or not a rescaling has been taking place, now the current location x is updated to the value of y, and the random walker is ready to take its next step.

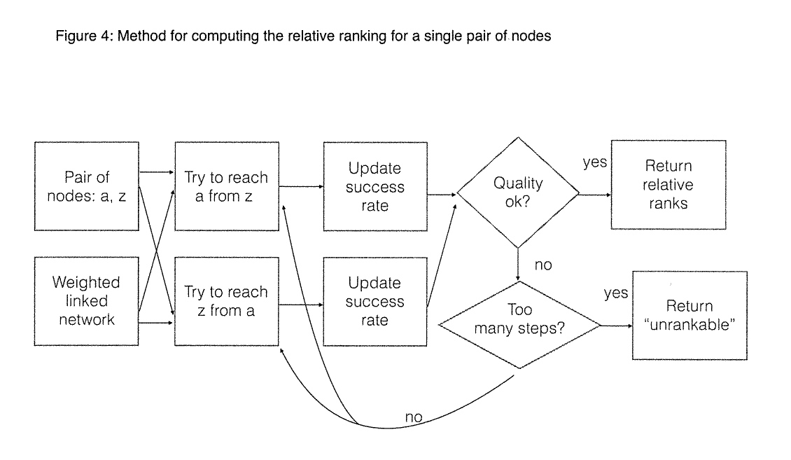

FIG. 4 shows the method of computing the relative importance ranking of two nodes. As an input, a pair of nodes a and z, and the full multi-linked network is needed. Then the reachability method described in FIG. 3 is run, both starting from a and starting from z. This can be done in parallel. Also, many instances of the same reachability method can be run in parallel. Whenever one of these methods gives the result ‘success’, ‘failure’, or ‘indeterminate’, this is recorded. The number of successes divided by the sum of the numbers of successes and failures is the success rate. The quality of the success rate is determined by the total number of successes (more is better), the total number of failures (more is better), and the total number of ‘indeterminate’ (less is better). It is then checked if the quality of the success rate meets some criteria specified by the system. If yes, the quotient of the success rates is returned as the relative importance rank of the two nodes. If not, the number of trials is tested against a pre-determined maximal number of trials. If this number is not reached yet, another run of the reachability method is started, which will potentially improve the quality of the results. If the maximal number of trials is reached without achieving sufficient quality, the system returns ‘unrankable’ which means that the two nodes an importance ranking of the two nodes makes little sense since the nodes live in too different parts of the network.

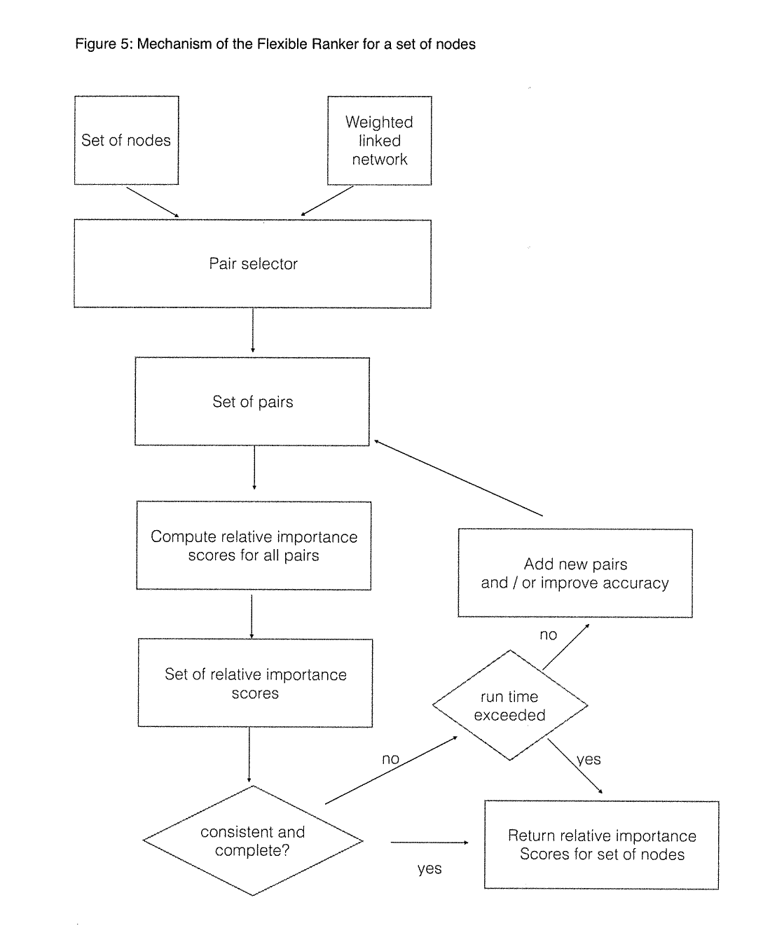

FIG. 5 shows the method of the Ranker. The ranker is given a set of nodes that need to be ranked, and a set of link weights for the full network. Then, first a pair selector is applied to the set of nodes, possibly taking information about the linked network into account. In one instance, the pair selector can select all possible pairs of nodes, but it can also choose a much smaller set of pairs, as long as it is possible to reach every selected node from every other selected node by moving only between paired nodes.

After applying the pair selector, one obtains a set of pairs. For each of these pairs, the relative importance ranking is computed as described in FIG. 4. Thus, one obtains a set of relative importance scores. Some of these scores may return ‘unrankable’. It is then checked whether these scores are consistent and complete. By complete, it is meant that it is possible to reach every node of the set that needs to be ranked, from every other node by only moving between two nodes with a valid relative importance score. By consistent, it is meant that if R(a,b) is the approximate relative importance ranking of a pair a, b (and similar for b, c and a, c), then R(a,b) should not be too different from R(a,c)*R(c,b) for any c. This way, R(a,b) is interpreted as the quotient w(a)/w(b) of two importance scores, as in this case it must be true that w(a)/w(b)=(w(a)/w(c))/(w(c)/w(a)).

If the set of scores is consistent and complete, it is returned as a result of the method. If it is not consistent and complete, a check is performed whether the run time is exceeded. If not, new pairs are added and/or the desired accuracy of the pair ranker is increased. If the run time is exceeded, the relative importance scores are returned, possibly along with warnings about those scores that are of low quality.

What is claimed is:

1. A method, executed by a processor of a computer system, to obtain a relative importance ranking of a subset of nodes of a larger, multiply linked set of nodes, wherein the nodes and links form a network, and wherein the links may have link weights attributed to them, wherein a link defines a reference to information stored on the nodes, so that each node provides information that are linked, the ranking is based on a structure of the links between the nodes, and is based on link weights that determine the importance of said links, comprising following steps:
forming a set of pairs, each consisting of two nodes a, b, of the subset of nodes to be ranked;
computing for each pair a,b a set of reachability scores R(a,b) and R(b,a), wherein the number R(a,b) reflects the probability that some random walk mechanism starting from a, and with a step distribution based on the weighted link structure of the network, reaches the node b before returning to its starting point a, and wherein the number R(b,a) is computed in the same way, with the roles of a and b exchanged;
storing the relative size of the reachability scores as a measure for the relative importance of the nodes;
ranking the full subset of nodes by using a sorting algorithms, using the stored relative importance of the nodes as a value of comparing two nodes and providing the ranked full subset of nodes as a relative importance ranking.

2. The method of claim 1, where the reachability score is computed in the following way:
performing for each formed pair a, b of nodes, a random walker method using the link weights for determining the next random step starting from a, and checking whether the random walker arrives at b without returning to a, if this happens, recording a journey as successful, performing the same with the roles of a and b interchanged by starting from b using the random walker method, performing the step several times according to a predefined repetition threshold, and storing the results of the journeys;
comparing for each pair a, b, the number of successful journeys from a to b to the total number of journeys, giving the reachability score R(a,b).

3. A method, executed by a processor of a computer system, to obtain a relative importance ranking of a subset of nodes of a larger, multiply linked set of nodes, wherein the nodes and links form a network, and wherein the links may have link weights attributed to them, wherein a link defines a reference to information stored on the nodes, so that each node provides information that are linked, the ranking is based on a structure of the links between the nodes, and is based on link weights that determine the importance of said links, comprising following steps:
forming a set of pairs, each consisting of two nodes a, b, of the subset of nodes to be ranked;
performing for each formed pair a, b of nodes, a random walker method using the link weights for determining the next random step starting from a, and checking whether the random walker arrives at b without returning to a, if this happens, recording a journey as successful, performing the same with the roles of a and b interchanged by starting from b using the random walker method, performing the step several times according to a predefined repetition threshold, and storing the results of the journeys;
comparing for each pair a, b, the number of successful journeys from a to b to the total number of journeys, obtaining a reachability score for b when starting from a, storing the relative size of the reachability scores from a to b when compared to the score from b to a as a measure for the relative importance of the nodes;
ranking the full subset of nodes by using a sorting algorithms, using the stored relative importance of the nodes as a value of comparing two nodes and providing the ranked full subset of nodes as a relative importance ranking.

4. The method according to claim 3, wherein the step of performing a random walker method for each pair a, b of nodes is computed in parallel.

5. The method according to claim 3, wherein the link weights are determined or influenced by the subset of nodes that needs to be ranked, or by the user, or by an external database, or by sensors, or by geographical location determining sensors, or by a combination of the above, and
wherein in case the user changes weights or additional links interactively, influencing the link weights, adjusting the ranking of the subset of nodes in real time to reflect these changes.

6. The method according to claim 3, comprising the step: introducing a measure of quality into the ranking, defined by a record that stores how many journeys of the random walker have to be cancelled because neither a nor b is reached after a large predefined number of steps.

7. The method according to claim 6, comprising the step: displaying the measure of quality to the user and indicating how much the ranking provided can be trusted.

8. The method according to claim 3, wherein the steps of claim 1 are calculated on a client computer, a server provides the necessary information about a network structure, and the client computer calculates the reachability score.

9. The method according to claim 3, wherein the multiply linked set of nodes are web-sites according, www, and links are web-site links within information provided by the web-sites, and the subsets is search results of a search service in the www.

10. The method according to claim 3, used to maintain the relative importance ranking of a multiply linked set of nodes, when some entries or links are added or removed, comprising the step:
determining by a crawler a sufficiently large neighbourhood A of the node(s) of the network that has been changed, wherein the sufficiently large neighbourhood A is defined by threshold parameters;
computing a relative importance of all the members of A;
identifying those entries of A that are only weakly affected by the change, but are still contained in the neighbourhood that has been computed; wherein a node b is weakly affected by the change if there is a node c outside A such that both the reachability scores J(b,c) and J(c,b) are much higher than the reachability scores J(a,b) and J(b,a) for any a in A that is connected to a link that has been added of removed; weakly connected nodes can be found by systematically testing this condition for those nodes of A where the graph distance to the nodes that have been affected by the change is maximal, the weakly connected node b keeps its old importance score w(b), while the other nodes in A obtain the new score w(b)*J(b,a)/J(a,b).

11. A computer system connected to a network, configured to obtain a relative importance ranking of a subset of nodes of a larger, multiply linked set of nodes, wherein a link defines a reference to information stored on the nodes in the network, so that each node provides information that are linked, the nodes and links form a network, and the ranking is based on a structure of the links between the nodes, and is based on link weights that determine the importance of said links, comprising:
a unit to form a set of pairs, each consisting of two nodes a, b, of the subset of nodes to be ranked;
a unit to compute for each pair a,b a set of reachability scores R(a,b) and R(b,a), wherein the number R(a,b) reflects the probability that some random walk mechanism starting from a, and with a step distribution based on the weighted link structure of the network, reaches the node b before returning to its starting point a, and wherein the number R(b,a) is computed in the same way, with the roles of a and b exchanged;
a unit to store the relative size of the reachability scores as a measure for the relative importance of the nodes;
a unit to ranking the full subset of nodes by using a sorting algorithms, using the stored relative importance of the nodes as a value of comparing two nodes and providing the ranked full subset of nodes as a relative importance ranking.

12. The computer system of claim 11, where the reachability score is computed in the following way:
performing for each formed pair a, b of nodes, a random walker method using the link weights for determining the next random step starting from a, and checking whether the random walker arrives at b without returning to a, if this happens, recording a journey as successful, performing the same with the roles of a and b interchanged by starting from b using the random walker method, performing the step several times according to a predefined repetition threshold, and storing the results of the journeys;
comparing for each pair a, b, the number of successful journeys from a to b to the total number of journeys, giving the reachability score R(a,b).

13. A computer system connected to a network, configured to obtain a relative importance ranking of a subset of nodes of a larger, multiply linked set of nodes, wherein a link defines a reference to information stored on the nodes in the network, so that each node provides information that are linked, the nodes and links form a network, and the ranking is based on a structure of the links between the nodes, and is based on link weights that determine the importance of said links, comprising:
a unit to form a set of pairs, each consisting of two nodes a, b, of the subset of nodes to be ranked;
a unit to perform for each formed pair a, b of nodes, a random walker method using the link weights for determining the next random step starting from a, and to check whether the random walker arrives at b without returning to a, if this happens, to record a journey as successful, to perform the same with the roles of a and b interchanged by starting from b using the random walker method, to perform the step several times according to a predefined repetition threshold, and to store the results of the journeys;
a unit to compare for each pair a, b, the number of successful journeys from a to b to the total number of journeys, to obtain a reachability score for b when starting from a, to store the relative size of the reachability scores from a to b when compared to the score from b to a as a measure for the relative importance of the nodes;
a unit to rank the full subset of nodes by using a sorting algorithms, to use the stored relative importance of the nodes as a value of comparing two nodes and providing the ranked full subset of nodes as a relative importance ranking.

14. The computer system according to claim 13, configured to perform a random walker method for each pair a, b of nodes is computed in parallel.

15. The computer system according to claim 13, comprising a unit to determine the link weights which are influenced by the subset of nodes that needs to be ranked, or by the user, or by an external database, or by sensors, or by geographical location determining sensors, or by a combination of the above, and wherein in case the user changes weights or additional links interactively, influencing the link weights, configured to adjust the ranking of the subset of nodes in real time to reflect these changes.

16. The computer system according to claim 13, comprising a unit to introduce a measure of quality into the ranking, defined by a record that stores how many journeys of the random walker have to be cancelled because neither a nor b is reached after a larger predefined number of steps.

17. The computer system according to claim 16, comprising a unit to display the measure of quality to the user and to indicate how much the ranking provided can be trusted.

18. The computer system according to claim 13, wherein the computers system is client computer, a personal computer or a server providing the necessary information about a network structure, and configured to calculate the reachability score.

19. The computer system according to claim 13, wherein the multiply linked set of nodes are web-sites according, www, and links are web-site links within information provided by the web-sites, and the subsets is a search results of a search service in the www.

20. The computer system according claim 13, comprising a unit to maintain the relative importance ranking of a multiply linked set of nodes, when some entries or links are added or removed, configured:
to determine by a crawler a sufficiently large neighbourhood A of the node(s) of the network that has been changed, wherein the sufficiently large neighbourhood A is defined by threshold parameters;
to compute a relative importance of all the members of A;
to identify those entries of A that are only weakly affected by the change, but are still contained in the neighbourhood that has been computed; a node b is weakly affected by the change if there is a node c outside A such that both the reachability scores J(b,c) and J(c,b) are much higher than the reachability scores J(a,b) and J(b,a) for any a in A that is connected to a link that has been added of removed; weakly connected nodes can be found by systematically testing this condition for those nodes of A where the graph distance to the nodes that have been affected by the change is maximal,
to keep for the weakly connected node b its old importance score w(b), while the other nodes in A obtain the new score w(b)*J(b,a)/J(a,b).
